(19) United States
(12) Patent Application Publication
(10) Pub. No.: US 2021/0028952 A1
(43) Pub. Date: Jan. 28, 2021

(54) VENUE SYSTEM JOIN INTO ONLINE MEETING SERVICES

(71) Applicant: Microsoft Technology Licensing, LLC, Redmond, WA (US)

(72) Inventors: Gregory Paul BARIBAULT, Sammamish, WA (US); ILYA BUKSHTEYN, Kirkland, WA (US); Sohail TARIQ, Redmond, WA (US)

(21) Appl. No.: 16/899,416

(22) Filed: Jun. 11, 2020

Related U.S. Application Data
(60) Provisional application No. 62/878,223, filed on Jul. 24, 2019.

(51) Int. Cl. H04L 12/18; G06F 16/955

(52) U.S. Cl. CPC H04L 12/1822; G06F 16/955; H04L 12/1818

(57) ABSTRACT

A venue system being able to join a meeting offered by a meeting service for which the venue system itself is not native. Thus, the venue system might join into meetings offered by a variety of meeting services, to thereby take advantage of the substantial offerings of a venue system. Furthermore, the joining is done via a web application that is indeed native to the meeting service. Because the native web applications is offered by the same entity as the meeting services, the web applications are typically kept up-to-date to thereby take fuller advantage of newer offerings of the meeting services as the capabilities of the meeting services evolve. Accordingly, even without updating the venue system itself, the venue system is capable of offering more up-to-date services of a variety of different meeting services even though the venue service itself is not native to those various meeting services.

### CROSS-REFERENCE TO RELATED APPLICATION

This application claims the benefit of U.S. Provisional Application No. 62/878,223, filed Jul. 24, 2019, which is hereby incorporated herein by reference in its entirety.

### BACKGROUND

Human beings are uniquely capable of communicating and have developed new modalities of communication over the course of the centuries. In modern times, computing and network technologies provide additional avenues for sharing information and ideas, thereby increasing the available modalities of communication and information sharing. For instance, we can now participate in online meetings and conference to share information and collaborate, even from remote locations. Online meetings are facilitated by client applications that are operated by devices or computing systems that are operated by participants in the online meetings, and meeting services that operate typically in a cloud computing environment.

Many modern online meeting services offer dedicated venue systems (e.g., room systems) which are designed to provide best-of-class experiences to users joining their online meetings. However, this best-of-class join experience is limited to the service for which the venue system was designed. The venue system and online meeting service that are designed specifically for each other (e.g., by the same company) are often termed as “native” to each other. To join another (non-native) online meeting service, the room system might use a protocol-based (e.g., Cloud Video Interop, or SIP protocol) meeting join experience. While this protocol-based approach provides basic audio/video and sharing options, it cannot provide the deep integration and full scope of features and functions that a native venue system could provide. This is because it is to keep applications on the venue system up-to-date with newer offerings of the meeting service when the application and meeting service are authored by different entities.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

Embodiments disclosed herein relate to a venue system being able to join a meeting offered by a meeting service for which the venue system itself is not native. Thus, the venue system might join into meetings offered by a variety of meeting services, to thereby take advantage of the substantial offerings of a venue system. Furthermore, the joining is done via a web application that is indeed native to the meeting service. Because the native web applications is offered by the same entity as the meeting services, the web applications are typically kept up-to-date to thereby take fuller advantage of newer offerings of the meeting services as the capabilities of the meeting services evolve. Accordingly, even without updating the venue system itself, the venue system is capable of offering more up-to-date services of a variety of different meeting services even though the venue service itself is not native to those various meeting services.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates a network environment in which the principles described herein may be employed, which includes a venue system (such as a room system) capable of communicating with both native and non-native online meeting services;

FIG. 2A illustrated shows example front-of-venue display and touch controller of an example venue system (in this case a room system);

FIG. 2B illustrates the user interface displayed on the touch controller of FIG. 2A in further detail;

FIG. 3 illustrates a flowchart of a method for a client application of a venue system to engage with meeting services in accordance with the principles described herein;

FIG. 4 illustrates a flowchart of a method for joining a meeting once the join control has been activated, in accordance with the principles described herein;

FIG. 5 illustrates a flowchart of a method for automatically generating a join URL by using a meeting identifier, thereby enabling joining of a meeting using just a meeting identifier in accordance with the principles described herein;

FIGS. 6A through 6C illustrate an example user experience associated with joining a meeting by providing a meeting identifier;

FIG. 7 shows the venue system after a swap operation, with the meeting experience being displayed on the touch controller instead of the front-of-room display; and

FIG. 8 illustrates an example computing system in which the principles described herein may be employed.

### DETAILED DESCRIPTION

Embodiments disclosed herein relate to a venue system being able to join a meeting offered by a meeting service for which the venue system itself is not native. Thus, the venue system might join into meetings offered by a variety of meeting services, to thereby take advantage of the substantial offerings of a venue system. Furthermore, the joining is done via a web application that is indeed native to the meeting service. Thus, even though venue system A is designed to connect natively with online meeting service A, the venue system A can also host and display the web-based online meeting application for non-native online meeting services B, C, and so forth. Furthermore, even though venue system A is not native to the online meeting service B, venue system A provides a native experience since venue system A hosts and displays content from a web application that is native to the online meeting experience B. Thus, the venue system might provide a native experience for joining both native and non-native online meeting services.

Because the native web applications is offered by the same entity as the meeting services, the web applications are typically kept up-to-date to thereby take fuller advantage of newer offerings of the meeting services as the capabilities of the meeting services evolve. Accordingly, even without updating the venue system itself, the venue system is capable of offering more up-to-date services of a variety of different meeting services even though the venue service itself is not native to those various meeting services.

In accordance with the principles described herein, a meeting client application of a venue system joins meetings of different meeting services depending on patterns associated with join Uniform Resource Locators (URLs). The client application maintains correlations between join URL patterns and each of the meeting services. The join URL could be an already existing join URL that a participant can simply select. Alternatively, the participant could even just enter a meeting identifier and potentially identity a meeting service provider, causing an associated join URL to be automatically generated.

To join into a meeting, the meeting client application accesses a pattern associated with a join URL received by the venue system (or automatically generated using the meeting identifier). The meeting client application determines that a particular supported meeting service is correlated with the accessed pattern using the maintained correlation. In response, a join control is activated. Accordingly, if the join control is selected by a user, the join URL is navigated to causing a connection to be made to a native web application of the meeting service that provided the join URL. In this case, the client application causes the display of the venue system to show a browser for rendering content of the joined meeting rendered by the native web application. More generally, the venue system's hardware may be used to render content to meeting participant(s) within the venue and/or receive content from participant(s) within the venue. Thus, simple one-touch join to non-native web applications is enabled.

In a typical meeting experience, it is possible to encounter a variety of URLs that participants can select. As an example, URLs may be exchanged in a chat associated with a meeting. In some embodiments, the client application monitors URLs that are provided in the context of the joined meeting so that only trusted URLs are selectable. This helps to protect the venue system and client application from becoming infected by malware because only trusted URLs can be selected by the venue system.

The meeting experience is then controlled by the venue system. This could be accomplished in any number of ways. As example, controls of the web application displayed on the primary venue display can be also rendered on a venue system control, such as on a venue control tablet. These controls may appear similar regardless of the identity of the meeting service. Furthermore, these controls on the venue system control can be associated with links that directly issue commands to the native web application, though the link may differ depending on the meeting service. Alternatively, the displayed content of the web application can be switched back and forth or duplicated between the primary venue system display and the venue system control. Accordingly, a unique mechanism for joining and controlling online meetings is described.

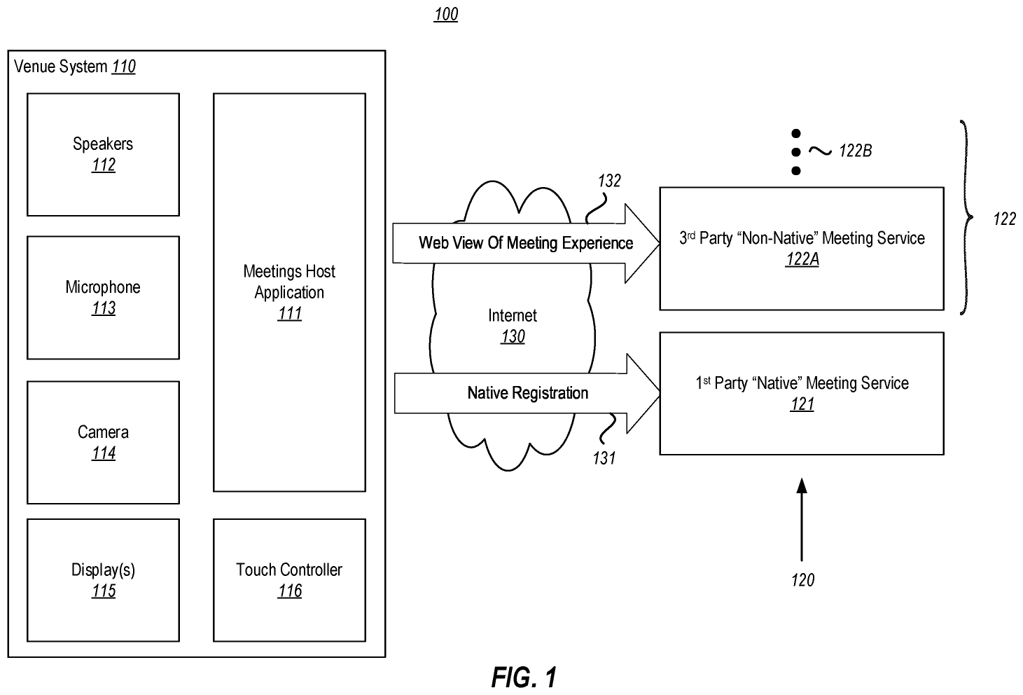

FIG. 1 illustrates a network environment 100 in which the principles described herein may be employed. The network environment 100 includes a venue system 110 that may connect with multiple online meeting services 120 via a network 130 such as the Internet. A meetings host application 111 (also called herein a “client application”) hosts the online meeting at the venue system 110 so that users within the venue may participate in online meetings hosted by any one of the online meeting services 120.

The online meeting services 120 are illustrated as including a native online meeting service 121 as well as one or more non-native online meeting services 122. The non-native online meeting services 122 are illustrated as including at least one non-native online meeting service 122A, but as represented by the ellipsis 122B, there may be any number of non-native online meeting services that the venue system 110 may potentially connect to. Each of the meeting services 120 is “online” in that it may be a network service or a cloud-based meeting service. Each online meeting service is responsible for authenticating and hosting all meeting participants, negotiating audio/video streaming between meeting participants, managing the state of shared content, and so forth.

An online meeting service is “native” to the meetings host application 111 if the online meeting service is provided by the same entity (e.g., the same company) as provided the meetings host application. As an example, the native online meeting service 121 is provided by the same entity as the meetings host application 111. On the other hand, an online meeting service is “non-native” to the meetings host application 111 if the online meeting service is provided by a different entity (e.g., a different company) as provided the meetings host application 111. As an example, the non-native online meeting service 122A is provided by a different entity as the meetings host application 111.

This venue may be a room, or any other space where users might gather to participate together in an online meeting experience by sharing the various hardware of the venue. Accordingly, as one example, the venue system 110 may be a room system. Other examples of a venue may be a stadium or amphitheater. The venue system 110 may connect (as represented by arrow 131) with a native online meeting service by registering with that service. This registration is a native registration as it follows the protocol established by the provider of both the meetings host application 111 and the native meeting service 121.

Significantly, the venue system may also connect (as represented by arrow 132) with a non-native online meeting service by 122B connecting with the web application of the non-native online meeting service to thereby obtain a web-based view of the online meeting experience. Although the web application of the non-native online meeting service is not native to the meetings host application 111, the web application is native to the online meeting service. Accordingly, the web application of each online meeting service is kept up-to-date with the latest offerings of the online meeting service.

The venue system 110 is a computing system that includes various in-venue peripheral physical devices—such as speakers 112, microphone(s) 113, camera(s) 114, front-of-venue display(s) 115, and touch controller(s) 116. The venue system 110 could be an Internet-of-Things (IoT) computer and runs an operating system that likewise runs the meetings host application 111 that is capable of connecting to any of the online meeting services 120.

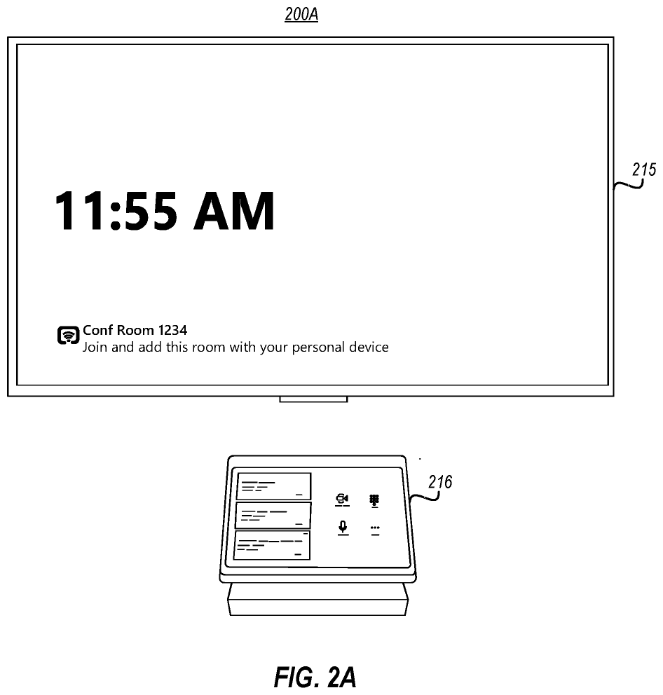

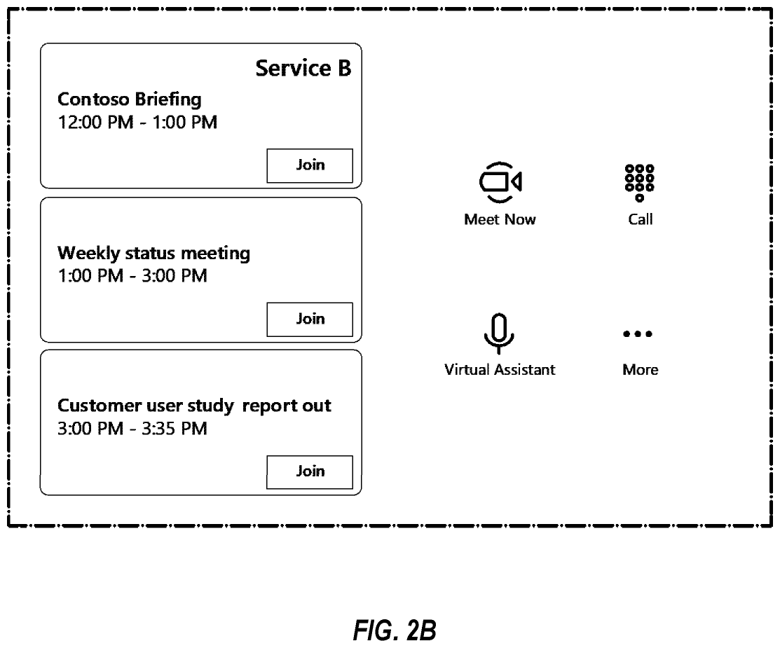

The front-of-venue display 115 presents the view of the local meeting account for any in-venue user to view. The local meeting account may be “in a meeting”, or “not in a meeting”. When the venue system is not in a meeting, the front-of-venue display may show content such as a clock, an upcoming meeting notification, and so forth (see e.g., FIG. 2A). When the venue system is in a meeting, the front-of-venue display shows the in-meeting experience, which might as an example consist of the video gallery of potentially remote participants, shared content (e.g., images, slide presentations, desktops, windows, video, electronic whiteboards, web pages, and so forth), notifications to users, and so forth.

The touch controller 116 provides the user input and control points for the meeting. These control points, as an example, include starting and stopping the meeting, controlling audio volume and mute states, controlling cameras, controlling front-of-venue displays, providing the user interface to add or remove attendees and generally manage the meeting roster. The touch controller 116 has touch screen capability for receiving that user input.

Audio/video devices (such as speakers 112, amplifiers, microphones 113 and cameras 114) provide or render media from the meeting service. These peripherals are connected to the venue system 110. The nature (number, type, positioning, orientation, etc.) of the peripheral physical devices may differ as appropriate given the venue.

An online meeting experience typically consists of four stages 1) meeting schedule, 2) meeting join/start, 3) in-meeting operation, and 4) meeting end/disconnect. However, one caveat to this flow is that the meeting schedule stage might not always occur as sometimes unscheduled meetings may be started ad hoc. Nevertheless, this description will discuss an example user experience beginning with the schedule stage.

### Scheduling

Embodiments described herein make it easy for the venue system to join even non-native online meeting services. The scheduling may include a Uniform Resource Locator (URL) or a link that allows the user to join a meeting with as little as one click of the link. Alternative, the user might copy and paste the URL into a browser. The client application parses the join URL to identify the service provider (or the online meeting service) of the online meeting, and determine if the venue system supports that online meeting service.

FIG. 2A illustrated below shows an example venue system 200A (in this case a room system). The illustration of the venue system 200A includes a depiction of an example front-of-venue display 215 which is an example of the front-of-venue display 115 of FIG. 1, and an example touch controller 216 which is an example of the touch controller 116 of FIG. 1. Here, the local meeting account of the venue system 200A is not in a meeting. Accordingly, the front-of-venue display 215 does not yet display meeting content, but simply shows a time. A touch controller 216 sits upon a table ready to receive touch input from in-room participants.

FIG. 2B illustrates the user interface displayed on the touch controller 216 in further detail. In the example of FIG. 2B, the touch controller illustrates three meetings that may be joined. The lower two meetings entitled “Weekly status meeting” and “Customer user study report out” are meetings offered by the native online meeting service (e.g., service A). However, the upper meeting entitled “Contoso Briefing” is a meeting offered by a non-native meeting service (e.g., service B). The join control for that meeting has been activated because the join URL for that meeting has been parsed and recognized as associated with online meeting service B, and the venue system 200A supports non-native online meeting service B.

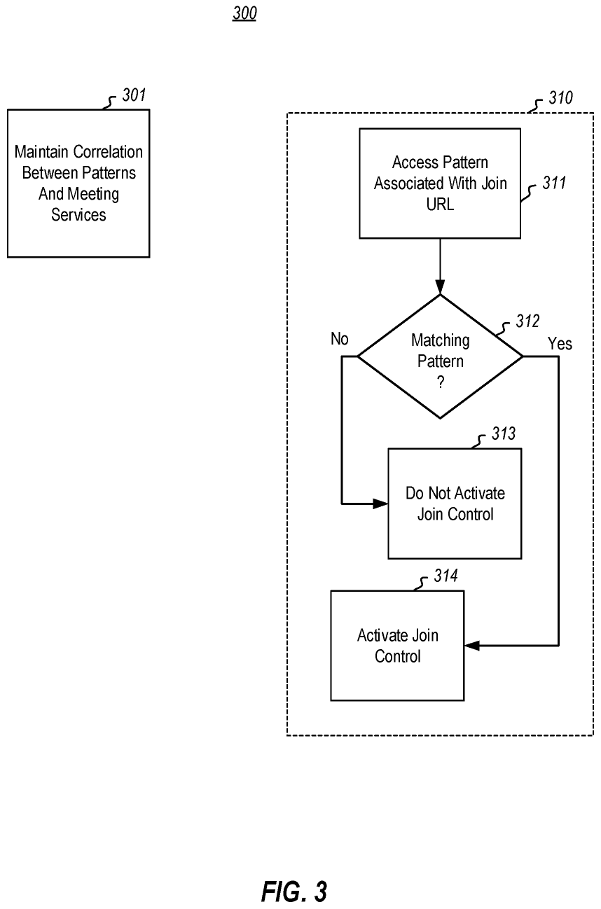

More details regarding how a join URL may be parsed to activate a join control in accordance with one embodiment are provided with reference to FIG. 3. FIG. 3 illustrates a flowchart of a method 300 for a client application of a venue system to engage with meeting services in accordance with the principles described herein. In this method 300, for a particular join URL for a particular meeting, the identity of the meeting service that is engaged with for that meeting depends on a pattern associated with the join URL. As an example only, the method 300 of FIG. 3 may be performed by the client application 111 of FIG. 1. Accordingly, the method 300 of FIG. 3 will now be described with frequent reference to both FIGS. 1 and 3.

The method 300 includes maintaining a correlation between patterns and the plurality of meeting services (act 301). The remainder of the method (in box 310) may be performed each time the venue system is to join into a meeting associated with any of the meeting services. As an example, if the method 300 is performed in the network environment 100 of FIG. 1, the content of box 310 might be performed each time the venue system 110 is to join into a meeting hosted by any of the meeting services 120.

The joining operation 310 is begun by accessing a pattern associated with a join URL received by the venue system (act 311). As an example, this pattern associated with the join URL might be a pattern of the join URL itself. The join URL might have certain recognizable patterns for each of the meeting services. For instance, the host, subdomain, domain name, and/or path of the join URL might have particular patterns or identities depending on the meeting service. As another example, this pattern associated with the join URL may be a pattern of the destination (e.g., the web page) accessed when the join URL is selected. This pattern might be a structural pattern (e.g., the layout or content) of the destination, and/or the function (e.g., of any script or code) embedded in the destination.

In one embodiment, the join URL is embedded within a meeting invitation. That meeting invitation may be within a calendar of the venue system. In that case, accessing the join URL might include retrieving the meeting invitation from the calendar, obtaining the join URL from the meeting invitation, and performing pattern matching on the join URL.

Returning to FIG. 3, the client application determines whether there are any meeting services that are correlated with the particular pattern of the join URL (decision block 312). If there are not (“No” in decision block 312), then no join control is activated (act 313). On the other hand, if there is a meeting service that is associated with the pattern associated with the join URL (“Yes” in decision block 312), then a join control is activated (act 314). This means that a user may then select the join control to cause the client application to navigate to the join URL.

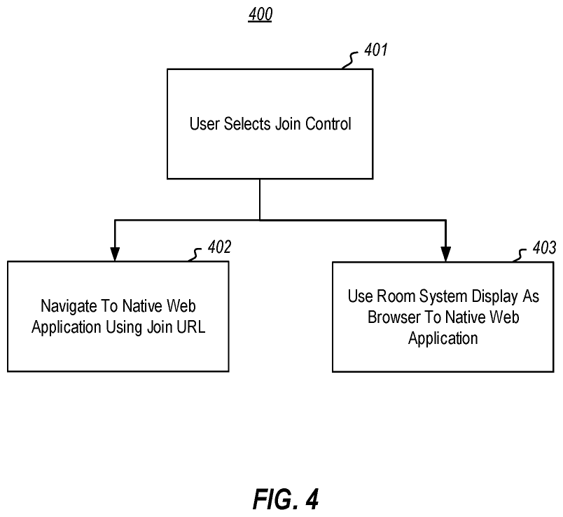

FIG. 4 illustrates a flowchart of a method 400 for joining a meeting once the join control has been activated. Upon the user selection of the join control (act 401), the client application of the venue system uses the join URL to navigate to the native web application (act 402). In addition, the display of the venue system is used as a browser for rendering content of the joined meeting provided by the native web application (act 403).

For instance, the client application navigates a browser to the native web application of the online meeting service, and renders content from that web application 131 so that the venue system can render the meeting content to the meeting participant(s) within the venue. More generally, the client application 111 may use all of the hardware of the venue system 110 in order to allow participant(s) within the venue to engage with the native web application to natively engage with the meeting service. For instance, speakers of the venue system 110 may be used to render audio content of the joined meeting provided by a native web application of the meeting service, microphone(s) of the venue system may be used to provide audio into the native web application of the meeting service, the camera(s) of the venue system 110 may be used to render still images and video into the native web application of the selected meeting service.

Additionally, software of the venue system may be further used to enhance the user experience. For example, the venue system may have speech to text capability, allowing the meeting audio to be transcribed. As another example, the venue system might have facial recognition technology allowing participants to be visually tagged with an identity for other participants in the meeting. Other software enhancements may also be provided by advanced venue systems.

### Join/Start

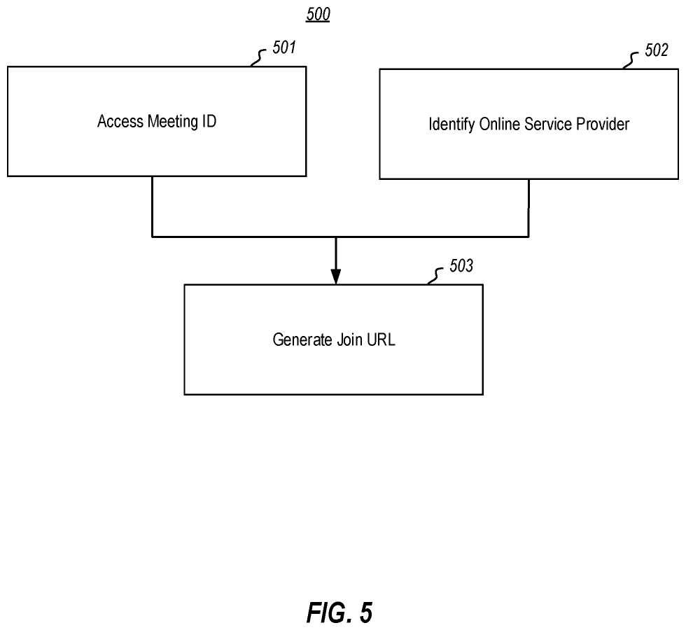

If the online meeting is not scheduled for the venue system account, or if the meeting scheduled has no recognizable join link information, the user may still be able to join a meeting hosted by a supported online meeting service by providing a meeting ID. In that case, the touch controller can display an option to join a meeting by meeting ID. In that case, the accessing of the join URL (act 311 of FIG. 3) is performed by performing the method 500 of FIG. 5.

FIG. 5 illustrates a flowchart of a method 500 for automatically generating a join URL by using a meeting identifier, thereby enabling joining of a meeting using just a meeting identifier in accordance with the principles described herein; In particular, the client application accesses a meeting identifier provided by a user (act 501), accesses an identity of a meeting service provider associated with the meeting identifier (act 502), and automatically generates the join URL using the meeting identifier and the identity of the meeting provider (act 503).

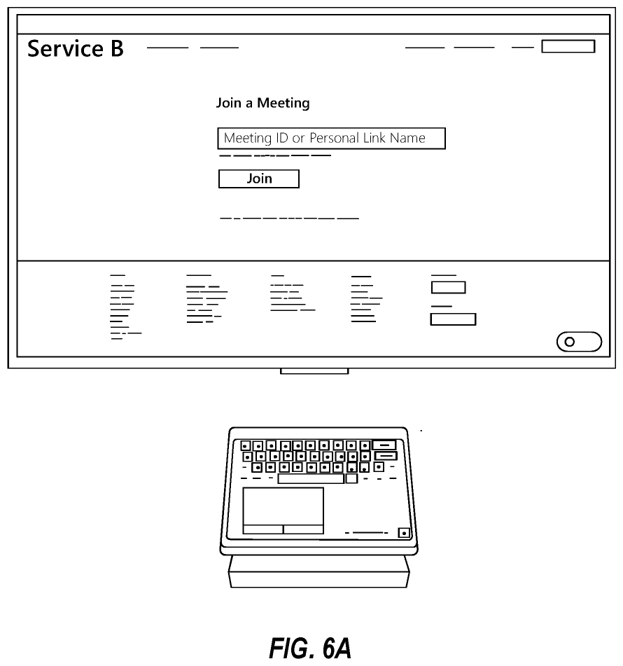

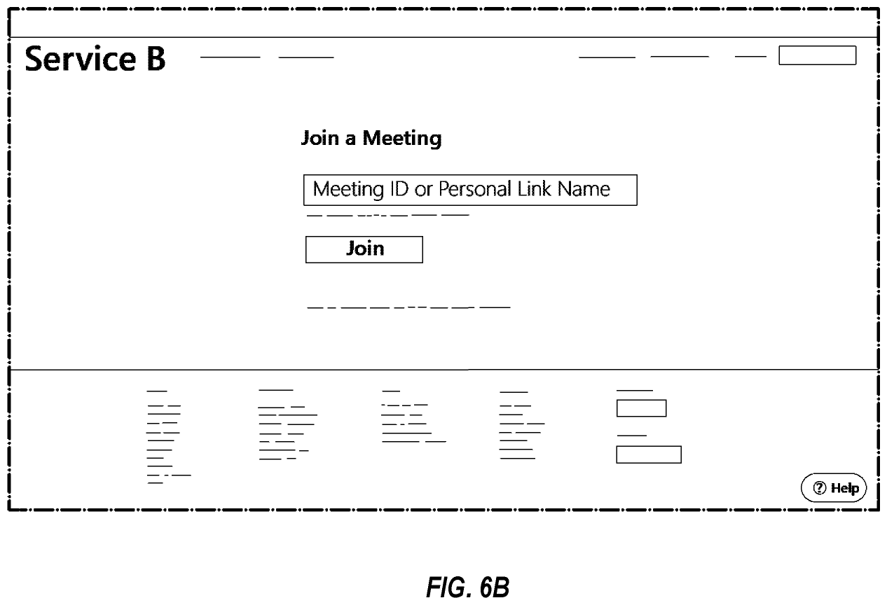

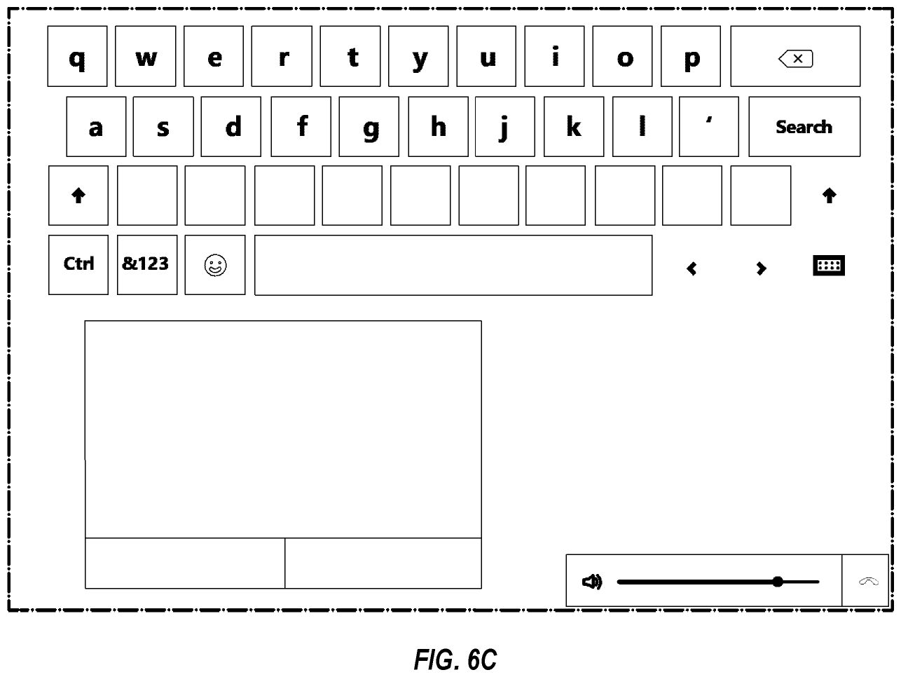

FIGS. 6A through 6C illustrate an example user experience associated with joining a meeting by providing a meeting identifier. When this option is selected, the venue system will prompt the user to select the online meeting service provider from a list of known online meeting service providers. Stated differently, the client application presents a meeting service provider identity entry user interface that the user can interact with to identify a meeting service provider. The client application performing the accessing of the identity of the meeting service provider (act 502) by interpreting user interaction with the meeting service provider identity entry user interface.

In addition, when the user has identified the online service provider, the client application will then prompt the user for the meeting ID(s) required to join. An example venue system in this state is illustrated in FIG. 6A. FIG. 6B illustrates only the front-of-venue display shown in FIG. 6A. Furthermore, note that the touch controller now shows (at the direction of the client application) a keyboard and tracking pad as shown in further detail in FIG. 6C. Thus, the user may easily interact with the touch controller to provide the meeting ID.

Thus, the client application is configured to present a meeting identifier entry user interface such as that of FIGS. 6A and 6B in which the user can enter a meeting identifier. Then, the accessing of the meeting identifier provided by the user (act 501) is performed by the client application detecting the meeting identifier that the user entered into the meeting identifier user interface. The client application may then use the meeting ID and identified online meeting service to generate a join URL (act 503). Additionally, authentication may be requested at this step to log the user into the online meeting service provider.

### In-Meeting Operation

While in the meeting hosted by a non-native online meeting service, the user will need to interact with the non-native online meeting service. There are many reasons to interact with the online meeting service. These reasons range from controlling the mute state, controlling volume, adding participants, stopping or starting the in-venue camera, viewing content or sharing content, changing the layout of the meeting experience, and many more. There will be four different ways described herein in which these interactions may happen, though the principles described herein are not limited to these four ways.

1) Deep Links into the Meeting Experience. If the client application of the venue system understands the commands and controls available, the client application may provide a direct button or function to provide the command from the meeting touch controller, and send that command into the web experience using a “deep link”. This direct button may be appear consistent across different online meeting services. For instance, if the client application understands the mute controls for multiple online meeting services, the client application may provide that mute button so that it appears the same regardless of the online meeting service, even though the structure of the sent command may be the same or differ across different online meeting services.

This approach is elegant, and allows a proper button to be provided on the touch controller to send a command to the online meeting service. For example, if the user wanted to mute the in-venue microphones, a mute button could be provided on the touch controller which (when selected) would send a mute command to the web application of the online meeting service which in turn mutes the venue from the online meeting service. Similarly, an “End meeting” button could be provided on the touch controller which, when selected, will send an end meeting command through the web application to disconnect from the online meeting, and then close the browser window on the front-of-venue display. This provides a simple one-touch command purpose-built for the meeting service.

2) Mouse/Keyboard based UI Navigation. Alternatively, or in addition, the client application may provide an on-screen keyboard and touchpad based control on the touch controller to provide the user with the ability to control the non-native online meeting service directly using their own user interface similar to how a user would operate the meeting application on their own desktops. FIG. 6C illustrates an example of that user interface. This remote keyboard and touchpad would be available for the user to operate the non-native online meeting experience. While perhaps not as elegant as deep links, it would provide access to every function possible for the online meeting service.

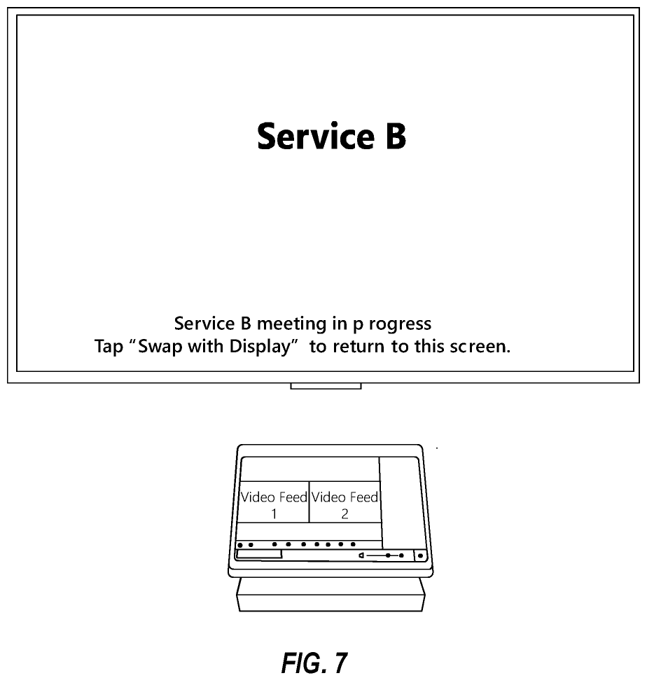

3) Swapping or Duplicating the Primary and Console Screens. In this option, the client application can enable the user to swap or duplicate the in-meeting experience that is displayed on the front-of-venue display (in the form of a web application) onto the console screen. Doing so would allow for direct, touch based interaction with the non-native online meeting service, activating any desired functions on the touch controller, and then swapping the screen back to the primary conferencing display. This operation would allow for control of the meeting, without disrupting audio or video. For instance, FIG. 7 shows the venue system after a swap operation, with the meeting experience being displayed on the touch controller instead of the front-of-room display. The user may thus interact with all of the controls on the touch controller to control the meeting experience. The touch controller may also be provided with a control to swap the display so that the meeting experience is again displayed on the front-of-venue display.

4. Abrupt Control of the Web Host. For some functions, such as ending the meeting, it may be possible to provide more abrupt control of the web host directly from the touch controller. In this case, the touch console will operate at the browser level, performing functions like closing and refreshing. These can be useful if there is no direct user interface UI to operate with a mouse/keyboard, and no ability to deep link into the experience. It would be limited in use since it could be destructive to the meeting.

### Meeting End/Disconnect

At the end of the meeting, the users in the room may disconnect from the meeting by either selecting the end-meeting option on the non-native online meeting service itself, or by selecting an end meeting control on the touch controller. Similar to other in-meeting interactions, selecting the end meeting function on the console will attempt to gracefully end the online meeting if it has the appropriate link into the web user experience and can properly end the meeting before closing the browser window. In cases where this is not possible, the in-room device may simply close the browser control and abruptly end the online meeting.

### Security

This approach to joining 3^{rd} party meeting services should be done safely. In addition to providing control and access to in-room audio/video devices, this approach should also protect the venue system from potential threats from web based experiences. For example, if the non-native online meeting service provides a chat interface, it may be possible for a remote attendee to send a chat message containing a malicious URL. If the in-room participants were able to click that URL and open the content, it could be damaging to the venue system.

To avoid this, the client application monitors URLs that are provided in the context of the joined meeting so that only URLs satisfying one or more predetermined criteria are selectable. These predetermined criteria could be that the URL is in a list of trusted URLs, or perhaps follows a pattern common to trusted URLs. Alternatively, the predetermined criteria might be that the URL is invoked in an isolated environment (e.g., on a virtual machine) and does not cause malicious activity to be attempted.

Accordingly, the principles described herein provide a substantial improvement in the art of online meetings performed by venue systems. Some of the systems described above (such as the venue system 101, and each of the meeting services 102) may be implemented by computing systems. Accordingly, a computing system will be described below with respect to FIG. 7. In that case, the functionality of the system may be performed by the computing system executing computer-executable instructions that are on one or more computer-readable media of the computing system, the computer-executable instructions being structured such that, when executed by the one or more processors of the computing system, the computing system is caused to perform the operations described herein.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

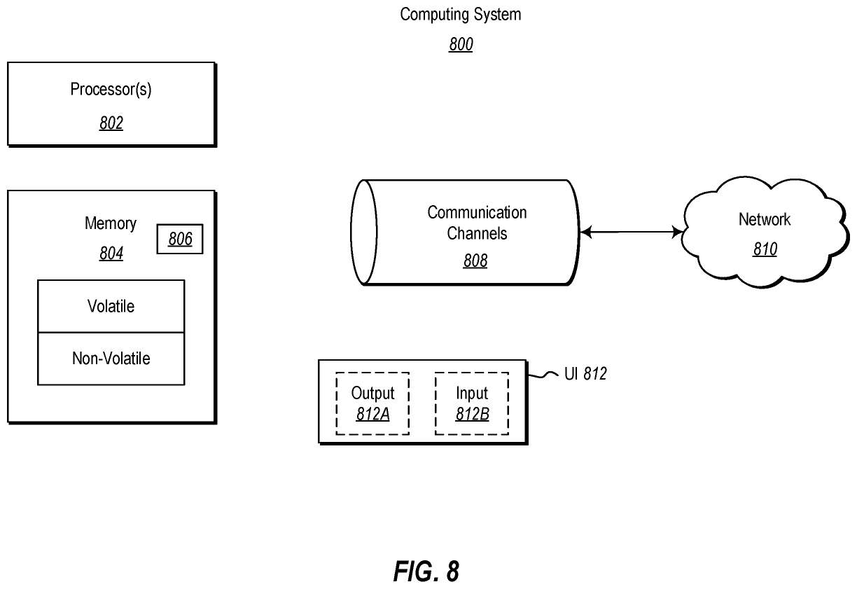

As illustrated in FIG. 8, in its most basic configuration, a computing system 800 typically includes at least one hardware processing unit 802 and memory 804. The processing unit 802 may include a general-purpose processor and may also include a field programmable gate array (FPGA), an application specific integrated circuit (ASIC), or any other specialized circuit. The memory 804 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 800 also has thereon multiple structures often referred to as an “executable component”. For instance, the memory 804 of the computing system 800 is illustrated as including executable component 806. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 804 of the computing system 800. Computing system 800 may also contain communication channels 808 that allow the computing system 800 to communicate with other computing systems over, for example, network 810.

While not all computing systems require a user interface, in some embodiments, the computing system 800 includes a user interface system 812 for use in interfacing with a user. The user interface system 812 may include output mechanisms 812A as well as input mechanisms 812B. The principles described herein are not limited to the precise output mechanisms 812A or input mechanisms 812B as such will depend on the nature of the device. However, output mechanisms 812A might include, for instance, speakers, displays, tactile output, virtual or augmented reality, holograms and so forth. Examples of input mechanisms 812B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, an some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, when executed by the one or more processors, cause the computing system to executing a meeting client application of a venue system, the meeting client application configured to join meetings of a plurality of different meeting services depending on patterns associated with join Uniform Resource Locators (URLs), the client application configured to:
maintain a correlation between patterns and the plurality of meeting services;
join a meeting associated with a meeting service of the plurality of meeting services by performing the following:
accessing a pattern associated with a join URL received by the venue system;
using the correlation to determine that the pattern is correlated with one of the plurality of meeting services;
in response to the determination, activating a join control in the venue system, wherein upon user selection of the join control, the join URL is selected; and
using a display of the venue system as a browser for rendering content of the joined meeting provided by a native web application of a particular meeting service that is also associated with the pattern associated with the join URL.

2. The computing system in accordance with claim 1, the venue system being a room system.

3. The computing system in accordance with claim 1, the client meeting application of the venue system being native to another of the plurality of meeting services other than the selected meeting service.

4. The computing system in accordance with claim 1, the accessed pattern associated with the join URL being a pattern of a web page accessed upon selecting the join URL.

5. The computing system in accordance with claim 1, the join URL being received by the venue system in a meeting invitation.

6. The computing system in accordance with claim 4, the meeting invitation being accessed from a calendar of the venue system.

7. The computing system in accordance with claim 1, the client application configured to access the join URL by performing the following:
accessing a meeting identifier provided by a user;
accessing an identity of a meeting service provider associated with the meeting identifier; and
automatically generating the join URL using the meeting identifier and the identity of the meeting service provider.

8. The computing system in accordance with claim 7, the client application configured to present a meeting identifier entry user interface in which the user can enter a meeting identifier, the accessing of the meeting identifier provided by the user being performed by the client application detecting the meeting identifier that the user entered into the meeting identifier user interface.

9. The computing system in accordance with claim 8, the client application configured to present a meeting service provider identity entry user interface that the user can interact with to identify a meeting service provider, the client application performing the accessing of the identity of the meeting service provider by interpreting user interaction with the meeting service provider identity entry user interface.

10. The computing system in accordance with claim 1, the client application configured to monitor URLs that are provided in the context of the joined meeting so that only URLs satisfying one or more predetermined criteria are selectable.

11. The computing system in accordance with claim 10, the predetermined criteria is that the URL is in a list of a trusted URLs.

12. The computing system in accordance with claim 10, the predetermined criteria is that the URL follows a pattern is in a list of a trusted URL patterns.

13. The computing system in accordance with claim 10, the predetermined criteria being that the invoking of the URL in an isolated environment does not cause particular actions to be attempted.

14. The computing system in accordance with claim 1, the client application also configured to provide input controls on a touch controller display of the venue system.

15. The computing system in accordance with claim 14, the client application configured to switch the browser to the touch controller display upon determining that the user is to input into the browser.

16. The computing system in accordance with claim 14, the client application configured to cast one or more input controls of the web application from the browser into the touch controller display, such that interfacing with the cast input control on the touch controller display results in the corresponding control of the web application being interface with.

17. The computing system in accordance with claim 14, the client application configured to display a plurality of controls that are common across the plurality of meeting services on the touch controller display of the venue system, wherein upon one of the plurality of controls being activated, the client application sends a message to the web application.

18. The computing system in accordance with claim 17, a structure of the sent message being the same regardless of the identity of the particular meeting service.

19. A method of joining a meeting using a venue system, the method comprising:
maintaining a correlation between patterns and a plurality of meeting services; and
joining a meeting associated with a meeting service of the plurality of meeting services by performing the following:
accessing a pattern associated with a join URL received by the venue system;
using the correlation to determine that the pattern is correlated with one of the plurality of meeting services;
in response to the determination, activating a join control in the venue system, wherein upon user selection of the join control, the join URL is selected; and
using a display of the venue system as a browser for rendering content of the joined meeting provided by a native web application of a particular meeting service that is also associated with the pattern associated with the join URL.

20. A computer program product comprising one or more computer-readable storage media having thereon computer-executable instructions that are structured such that, when executed by one or more processors of a computing system, the computing system to is caused to:
maintain a correlation between patterns and a plurality of meeting services; and
join a meeting associated with a meeting service of the plurality of meeting services by performing the following:
accessing a pattern associated with a join URL received by the venue system;
using the correlation to determine that the pattern is correlated with one of the plurality of meeting services;
in response to the determination, activating a join control in the venue system, wherein upon user selection of the join control, the join URL is selected; and
using a display of the venue system as a browser for rendering content of the joined meeting provided by a native web application of a particular meeting service that is also associated with the pattern associated with the join URL.
